(19) United States
(12) Patent Application Publication
(10) Pub. No.: US 2017/0021690 A1
(43) Pub. Date: Jan. 26, 2017

(54) SECURING ATTACHMENTS TO WORK VEHICLES WITH SUSPENSION CONTROL

(71) Applicant: DEERE & COMPANY, MOLINE, IL (US)

(72) Inventors: DONALD R. MILLER, CEDAR FALLS, IA (US); Andrew B. Peterson, Hudson, IA (US); Mark J. Tieszen, Hudson, IA (US); William R. Zenk, Waterloo, IA (US)

(21) Appl. No.: 14/805,096

(22) Filed: Jul. 21, 2015

(51) Int. Cl. B60G 17/0195; B60P 7/135; B60G 17/017; A01B 59/06

(52) U.S. Cl. CPC B60G 17/0195; A01B 59/064; B60P 7/135; B60G 17/017; B60G 2300/082

(57) ABSTRACT

A system and a method for securing an attachment to work vehicle with a chassis and a suspension are described. A mounting frame with a frame attachment point disposed on a support can be attached to a work vehicle. The suspension can be caused to lower the mounting frame relative to ground by lowering the chassis of the work vehicle. The work vehicle can be maneuvered to align the frame attachment point with a corresponding attachment point on the attachment. The suspension can then be caused to raise the mounting frame relative to ground by raising the chassis of the work vehicle. The frame attachment point can thereby engage the corresponding attachment point on the attachment, as the mounting frame is raised, in order to lift the attachment, with the attachment being thereby supported by the work vehicle solely via the mounting frame.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to mounting attachments to work vehicles, including agricultural attachments for tractors.

### BACKGROUND OF THE DISCLOSURE

In agricultural and other applications, it may be useful to temporarily secure different attachments to a work vehicle. For example, a first attachment such as a liquid reservoir or other container, or a farming implement or tool, can be temporarily secured to a tractor for use during a particular set of farming operations. For different operations, the first attachment can then be replaced with another, different attachment.

Under conventional systems for securing an attachment to a work vehicle, a hydraulic hitch assembly can be rigidly attached to the chassis of the vehicle. Arms of the hitch assembly can be hydraulically lowered, and the vehicle positioned near the attachment. The arms can then be hydraulically raised, with the attachment being thereby lifted from the ground for use with the vehicle. These systems can be relatively expensive, however, and can introduce additional maintenance and power needs for the vehicle.

Other conventional systems can control a vehicle suspension to help secure an attachment to a vehicle. Such systems, however, can secure only a limited number of attachment types to a vehicle, can be incompatible with useful agricultural (and other) tools and containers, and can still require relatively complex mounting arrangements.

### SUMMARY OF THE DISCLOSURE

A system and a method for securing attachments to work vehicles are disclosed.

According to one aspect of the disclosure, a method for securing an attachment to a mounting frame of a work vehicle can include causing a suspension of the work vehicle to lower the mounting frame relative to ground by lowering a chassis of the work vehicle. The work vehicle can be maneuvered to align a frame attachment point of the mounting frame with a corresponding attachment point on the attachment. The suspension can then be caused to raise the mounting frame relative to ground by raising the chassis of the work vehicle. The frame attachment point can engage the corresponding attachment point on the attachment, as the mounting frame is raised, in order to lift the attachment. The attachment can thereby be supported by the work vehicle solely via the mounting frame.

According to another aspect of the disclosure, an attachment system can be used to secure an attachment to a work vehicle with a suspension. A mounting frame can be attached to the work vehicle at a vehicle attachment point, with frame attachment point on a support of the mounting frame disposed forward or rearward of a leading or trailing end, respectively, of the work vehicle. A user interface can be configured to receive user commands for adjustment of the suspension. A controller can be configured to cause the suspension to be raised and lowered relative to ground based upon the user commands received at the user interface. When the frame attachment point is vertically aligned with a corresponding attachment point on the attachment, and a user command for lifting is received at the user interface, the controller can cause the suspension to raise the mounting frame relative to ground by raising a chassis of the work vehicle, such that the mounting frame lifts the attachment.

According to still another aspect of the disclosure, an attachment system for a work vehicle can include a three-point hitch attached to the work vehicle at a vehicle attachment point disposed at a front of the work vehicle. The three-point hitch can include two non-pivoting lower supports extending forward of a leading end of the work vehicle, such that a respective hitch point on each of the lower supports is disposed forward of the leading end of the work vehicle. The three-point hitch can also include a pivoting upper support with a hitch point on the upper support that is also disposed forward of the leading end of the work vehicle.

An attachment can include legs to support the attachment relative to ground, the legs being foldable, collapsible, adjustable with regard to height, or non-destructively removable from the attachment. The attachment can further include three hitch points corresponding, respectively, to the three hitch points on the upper and lower supports of the three-point hitch.

A user interface can be configured to receive user commands for adjustment of a suspension of the work vehicle. A controller can be configured to cause a front portion of the suspension of the work vehicle to raise and lower a chassis of the work vehicle relative to ground, based upon the user commands received at the user interface. When the hitch points on the lower supports are vertically aligned, respectively, with the corresponding hitch points of the attachment, and a user command for lifting is received at the user interface, the controller can cause the front portion of the suspension to raise the three-point hitch relative to ground by raising the chassis of the work vehicle. The three-point hitch can thereby lift the attachment, such that the attachment can be supported by the work vehicle solely via the three-point hitch.

The details of one or more embodiments are set forth in the accompanying drawings and the description below. Other features and advantages will become apparent from the description, the drawings, and the claims.

### BRIEF DESCRIPTION OF THE DRAWINGS

FIG. 1A is a side elevational view of an attachment and a tractor with an attachment system according to one embodiment of this disclosure;

FIG. 1B is a perspective view of a three-point hitch included in the attachment system of FIG. 1A;

FIG. 2 is a side elevational view of the attachment and the tractor of FIG. 1A, with the tractor maneuvered to align the three-point hitch with the attachment; and

FIG. 3 is a side elevational view of the attachment and the tractor of FIG. 1A, with the attachment lifted by and secured to the tractor.

Like reference symbols in the various drawings indicate like elements.

### DETAILED DESCRIPTION

The following describes one or more example embodiments of the disclosed attachment system and method, as shown in the accompanying figures of the drawings described briefly above. Various modifications to the example embodiments may be contemplated by one of skill in the art.

As used herein, unless otherwise limited or modified, lists with elements separated by “and” that are preceded by the phrase “one or more of” or “at least one of” indicate configurations or arrangements that potentially include individual elements of the list, or any combination thereof. For example, “at least one of A, B, and C” or “one or more of A, B, and C” can indicate only A, only B, only C, or any combination of two or more of A, B, and C (e.g., A and B; B and C; A and C; or A, B, and C).

As noted above, it can be useful to temporarily secure different attachments to a work vehicle. The method and system described herein can be used for this purpose, including with vehicles that include controllable suspensions.

In some embodiments, the disclosed attachment system can include (and the disclosed method can employ) a mounting frame that is attached to a work vehicle with a support of the mounting frame extending forward of a leading end of the relevant work vehicle. For example, a rigid three-point hitch can be secured to the front end of a tractor chassis, such that arms of the hitch extend generally forward of the chassis and the front body of the tractor.

With the mounting frame in place (or prior to attaching the mounting frame), the leading end of the vehicle can be lowered by controlling a suspension of the vehicle. For example, a controller can cause a hydraulic system in the suspension to generally lower the front of the chassis relative to the ground. The vehicle can then be maneuvered (e.g., driven) such that attachment points on the mounting frame are generally aligned with attachment points on a front attachment, and the leading edge of the vehicle raised to lift the attachment from the ground. In this regard, the extension of the mounting frame support ahead of the vehicle can provide not only useful attachment points for many kinds of attachments, but also a visual reference for operators of the vehicle that can help the operators align the mounting frame with the attachment.

In other embodiments, the attachment points can be lowered by lowering another portion of the chassis, or by lowering the chassis as a whole. For example, with a mounting frame secured to the vehicle such that the mounting frame extends rearward of a trailing end of the vehicle, the rear suspension can be controlled to lower the rear of the chassis relative to the ground. The vehicle can then be maneuvered to align attachment points on the mounting frame with attachment points on a rear attachment, and the rear suspension controlled to raise the rear of the chassis and the attachment.

In some embodiments, an attachment can be particularly configured for use with such an attachment system. For example, an attachment can include adjustable or removable legs to support the attachment relative to the ground before the attachment is lifted by the mounting frame. Once the attachment has been lifted, the legs can then be adjusted (e.g., folded, collapsed, telescoped, and so on) or removed, so as not to interfere with use of the attachment and the vehicle. Before the attachment is released from the vehicle, the legs can then be re-adjusted or replaced, so as to again support the attachment once it has been lowered.

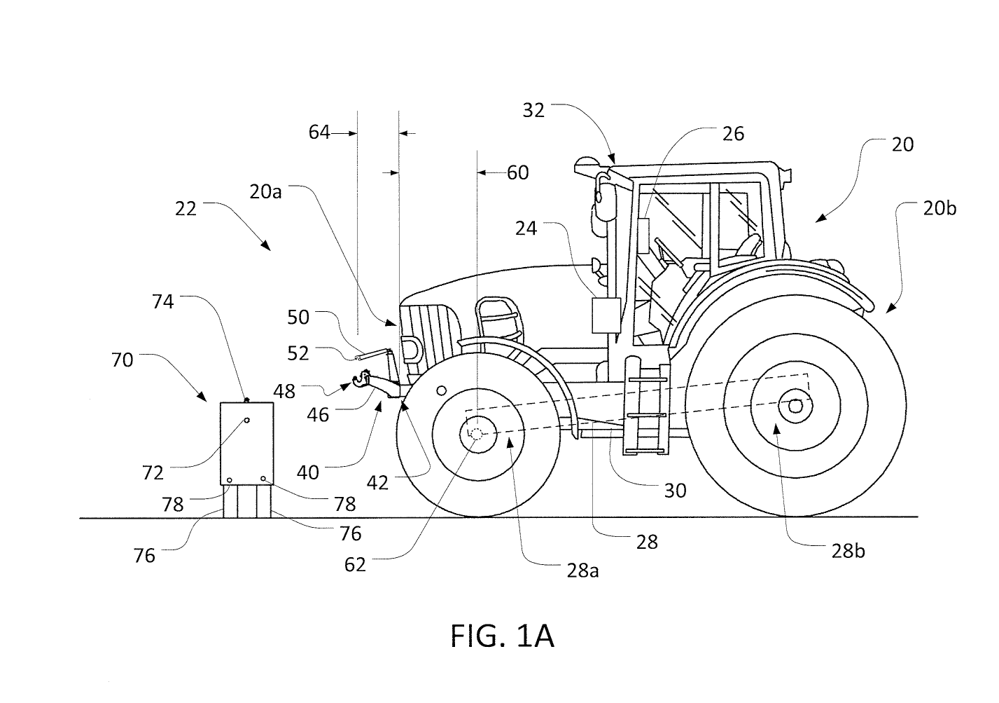

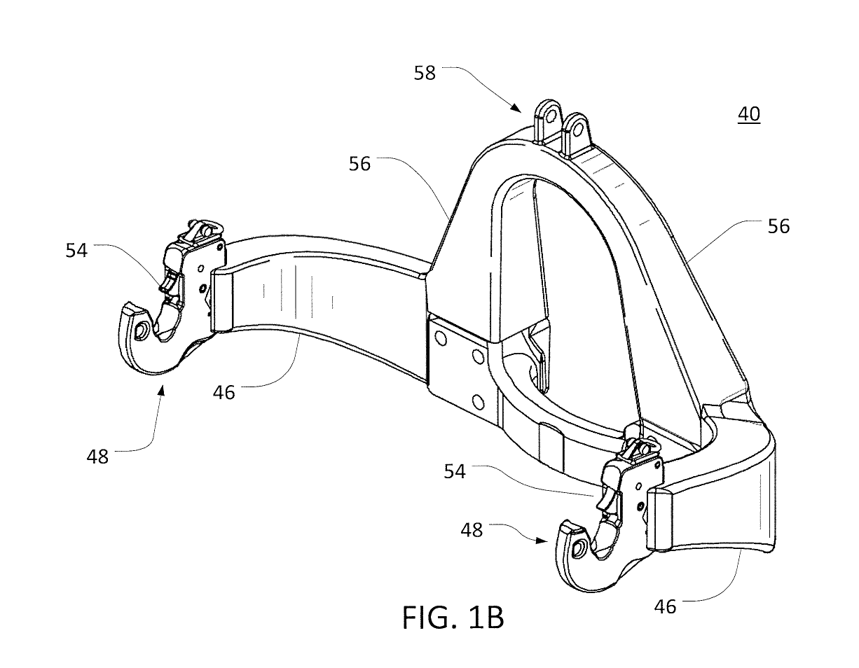

FIG. 1A illustrates a tractor 20 with an attachment system 22 according to one embodiment of this disclosure. It will be understood that the tractor 20 is depicted as an example only, and that the attachment system 22 (and other embodiments of the disclosure) can be used with other types of work vehicles.

The tractor 20 can include a controller 24, which can include one or more computing devices include various processor devices and various associated memory architectures. In certain embodiments, the controller 24 can additionally (or alternatively) include various other electronic control circuits and devices (e.g., various power electronics devices or programmable circuits).

In certain embodiments, the controller 24 can be in communication with various switches, controls and other interfaces or input devices. For example, a user interface 26 (e.g., a touchscreen interface, joystick, button panel, and so on) can be included in a cab 32 of the tractor 20. The user interface 26 is generally in communication with the controller 24, such that commands received at the interface 26 can be processed by the controller 24, and signals from the controller 24 can cause the interface 26 to display various interfaces and notifications. The controller 24 can also be in communication with various sensors, actuators, or other devices distributed on the tractor 20, or elsewhere. For example, the controller 24 can be in communication with sensors or actuators for a suspension 28 for a chassis 30 of the tractor 20.

The suspension 28 can generally support the chassis 30 relative to the ground and in some embodiments can be configured as a hydraulic suspension. In some embodiments, the suspension 28 can be controlled to raise or lower the chassis 30 relative to the ground. For example, based upon automated signals from the controller 24 or commands from the user interface 26, the suspension 28 can be controlled to raise or lower the chassis 30.

In some embodiments, the chassis 30 can be raised or lowered at a leading end, a trailing end, or in other areas, depending on the signals received. For example, a leading portion 28a of the suspension 28 (or, generally, a front suspension) can be actuated to raise or lower a leading end 20a of the tractor 20 (via the chassis 30), a trailing portion 28b of the suspension (or, generally, a rear suspension) can be actuated to raise or lower a trailing end 20b of the tractor 20 (also via the chassis 30), or the leading and trailing portions 28a and 28b of the suspension 28 can be collectively actuated to raise or lower the chassis 30 as a whole.

Generally, a mounting frame (e.g., a three-point hitch 40) can be attached to the tractor 20 at various tractor attachment points 42 at the leading end 20a of the tractor 20. The attachment points 42 can include mounting holes, brackets, or other attachment devices secured to (or formed with) the chassis 30 of the tractor 20, such that the mounting frame can be attached to the tractor 20 using bolts, pins, hooks, and so on. In some embodiments, the attachment points 42 can correspond to welds between the mounting frame and the chassis 30.

In the embodiment depicted in FIG. 1A, the three-point hitch 40 is attached at the leading end 20a of the tractor 20. Accordingly, discussion herein may address structures and operations for attaching a front-mounted attachment to the tractor 20. In some embodiments, mounting frames can be attached to vehicles at other locations. For example, a mounting frame (e.g., another three-point hitch (not shown)) can be attached at attachment points at the trailing end 20b of the tractor 20, such that the mounting frame can be used to attach a rear-mounted attachment to the tractor 20. One of skill in the art will recognize that similar structures and operations to those described herein for front-mounted mounting frames can also be applied (with appropriate directional modification) for rear-mounted mounting frames. For example, discussion regarding using the suspension 28 to lower the leading end 20a of the tractor 20, in order to secure a front-mounted attachment to the tractor 20, may correspond to similar operations for lowering the trailing end 20b of the tractor 20, in order to secure a rear-mounted attachment to the tractor 20.

As illustrated in detail in FIG. 1B, the three-point hitch 40 includes two lower supports configured as lower support arms 46. With the three-point hitch 40 secured at the attachment points 42 (see FIG. 1A), the lower support arms 46 can generally extend forward of the leading end 20a of the tractor 20 (see FIG. 1A). Accordingly, respective hitch points 48 on the lower support arms 46 are disposed generally forward of the leading end 20a of the tractor 20, such that the hitch points 48 can engage attachment points on an attachment disposed ahead of the tractor 20. (In other configurations, the hitch points 48 could be disposed behind the tractor 20, or in other relative positions, as may be useful for attachments disposed behind the tractor 20 or elsewhere.) The three-point hitch 40 can also include a pivoting upper arm 50 (not shown in FIG. 1B) attached to a pin-and-lug arrangement 58 (pin not shown) on the upper supports 56, with a hitch point 52 on the upper arm 50 also being disposed generally forward of the leading end 20a of the tractor 20.

As depicted, the hitch points 48 are configured as open hooks, which can be useful for quick attachment to attachment points configured as mounting pins (e.g., as can be included on various attachments). Movable latches or clasps 54 can be provided on the open hooks, in order to help retain corresponding pins or other features on a relevant attachment. Likewise, the hitch point 52 can be configured as a hook with a closing clasp, in order to help retain a corresponding pin or other feature on the relevant attachment.

In other embodiments, other types of frame attachment points can be used, as can other types of mounting frames. For example, lockable attachment devices, clips, hooks, brackets with holes for mounting pins, and so on can be used as various attachment points. Likewise, mounting frames with different numbers or configurations of supports are possible, including mounting frames with multiple adjustable (e.g., foldable or pivotable) supports.

In some embodiments, it may be useful to configure the hitch 40 (or another mounting frame) with particular dimensions relative to certain dimensions of the tractor 20 (or other vehicle). As depicted in FIG. 1A, for example, the tractor 20 generally exhibits a front overhang distance 60, as measured between the centerline of a front axle 62 of the tractor 20 and the attachment points 42 at which the three-point hitch 40 is secured to the chassis 30. Further, the three-point hitch 40 exhibits a front extension distance 64, as measured between the attachment points 42 and the hitch points 48. Usefully, the three-point hitch 40 can be configured such that the front extension distance 64 is somewhat smaller than the front overhang distance 60. For example, to avoid excessive load on the suspension 28 the distance 64 can be configured to be 60% or less of the distance 60. Similar dimensional relationships can be used with a mounting frame (e.g., another three-point hitch) disposed elsewhere with respect to the tractor 20. For example, for a rear-mounted mounting frame, the distance between the trailing end 20b of the tractor 20 and attachment points between a rear-mounted mounting frame and the tractor 20 can be 60% or less of the distance between the trailing end 20b of the tractor 20 and rearwardly extending attachment points on the mounting frame (e.g., attachment points for securing a rear-mounted attachment to the mounting frame).

FIG. 1A further illustrates an attachment 70 configured to be secured to the tractor 20 using the three-point hitch 40. In the figures, the attachment 70 is depicted schematically and it will be understood, accordingly, that a variety of attachment types are possible. In some embodiments, the attachment 70 can be a box-like container, as can be useful for transporting tools, parts, rocks, plants, or other materials. In other embodiments, other configurations of the attachment 70 are possible, including ballast weights, liquid tanks, lifts or supports for motorized vehicles (e.g., ATVs) or motorized vehicles themselves, agricultural implements (e.g., sprayers, seeders, or ground-conditioning tools) and so on.

Generally, an attachment contemplated by this disclosure can include various types of attachment devices, such as mounting pins, hooks, clips, brackets with mounting holes, and so on. As depicted, the attachment 70 includes a set of mounting pins 72, configured to be received by the open-hook hitch points 48 of the three-point hitch 40. The attachment 70 also includes an upper pin-and-lug arrangement 74, configured to be engaged by the hooked hitch point 52 of the upper arm 50. In other embodiments, other types or numbers of attachment devices, collectively defining corresponding attachment points for the relevant attachment, are possible. In other embodiments, the arrangement 74 can alternatively (or additionally) be configured as a rigid support extending substantially farther above the top of the body of the attachment 70, or in various other ways.

In some embodiments, it can be useful to support an attachment relative to the ground prior to securing the attachment to a vehicle. For example, a set of legs can be provided, which can support the attachment at a height that is compatible with a mounting frame of the vehicle and the range of vehicle lifting and lowering that can be provided by a relevant suspension (or suspension portion). In some embodiments, it can be useful for supports for an attachment to be adjustable or removable, once the attachment has been secured to the mounting frame, such that the attachment supports do not interfere with operation of the vehicle or use of the attachment.

In the embodiment depicted, the attachment 70 includes a set of legs 76 that support the attachment 70 relative to the ground. The legs 76 are pinned to the attachment 70 with pins 78, such that the legs 76 can be removed by removing the pins 78, once the attachment 70 has been secured to the tractor 20 (via the three-point hitch 40). In other embodiments, other types of supports (e.g., other rigid frames) can be used, as can other devices for adjusting or non-destructively removing the legs (e.g., telescoping or other collapsible arrangements, folding frames, snap-fit or simple contact arrangements, and so on).

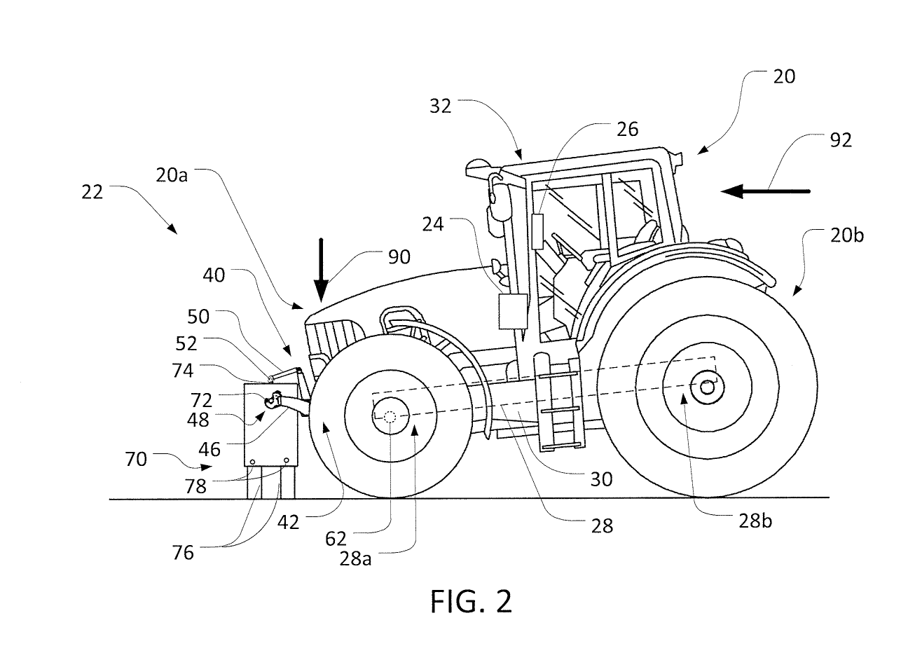

As illustrated in FIG. 2, in order to secure the attachment 70 to the tractor 20, the controller 24 can cause the suspension 28 to lower the chassis 30 relative to the ground. In the implementation depicted, as indicated by arrow 90, the leading portion 28a of the suspension 28 has been actuated, such that the leading portion of the chassis 30 has been pivoted downward. In other embodiments, the chassis 30 can be lowered in other ways, including in a non-pivoting movement. Because the three-point hitch 40 is secured to the chassis 30, lowering the chassis 30 with the suspension 28 also causes the three-point hitch 40, including the lower support arms 46, to be lowered. Accordingly, the hitch points 48 can be generally lowered to a height that is somewhat below the mounting pins 72 on the attachment 70.

With the hitch points 48 appropriately lowered (i.e., via actuation of the suspension 28), the tractor 20 can then be maneuvered (e.g., driven forward, as indicated by arrow 92) to align the hitch points 48 with the mounting pins 72. Where the mounting pins 72 are configured to engage the hitch points 48 from above, this can include maneuvering the tractor 20 such that the hitch points 48 are vertically aligned with, but somewhat below, the hitch points 48. For other types of attachment points on a mounting frame or an attachment, the tractor 20 can be maneuvered to provide other types of alignment.

The actuation of the suspension 28 to lower the chassis 30 can be controlled in various ways. In some implementations, the controller 24 can be configured to cause the suspension 28 to be lowered based upon active, ongoing control by a user. For example, a user can engage the user interface 26 to continually instruct the controller 24 (e.g., via a touchscreen button) to lower the chassis 30 via the suspension 28, with the lowering of the chassis 30 continuing only as along as the user provides the instructions (and the suspension remains within its maximum range of travel). In some implementations, the controller 24 can be configured to cause the suspension 28 to be lowered based upon other types of user input. For example, a user can provide a target end height or a simple “Lower Suspension” instruction via the user interface 26 and the controller 24 can automatically lower the chassis 30 via the suspension 28 to the commanded height or a preset configuration. In some implementations, the controller 24 can be in communication with sensors or lookup tables so as to automatically determine an appropriate chassis height for a particular attachment and mounting frame.

Similarly, maneuvering the tractor 20 to appropriately align the attachment points on the three-point hitch 40 (or other mounting frame) with the attachment points on the attachment 70 can be controlled in various ways. In some implementations, a user can manually maneuver the tractor 20 (e.g., via control pedals, joysticks, and so on) in order to achieve the appropriate alignment. In some implementations, the controller 24 can be configured to automatically maneuver the tractor 20, based upon predetermined maneuvering settings or based upon data from sensors for detecting the relative location of the attachment 70.

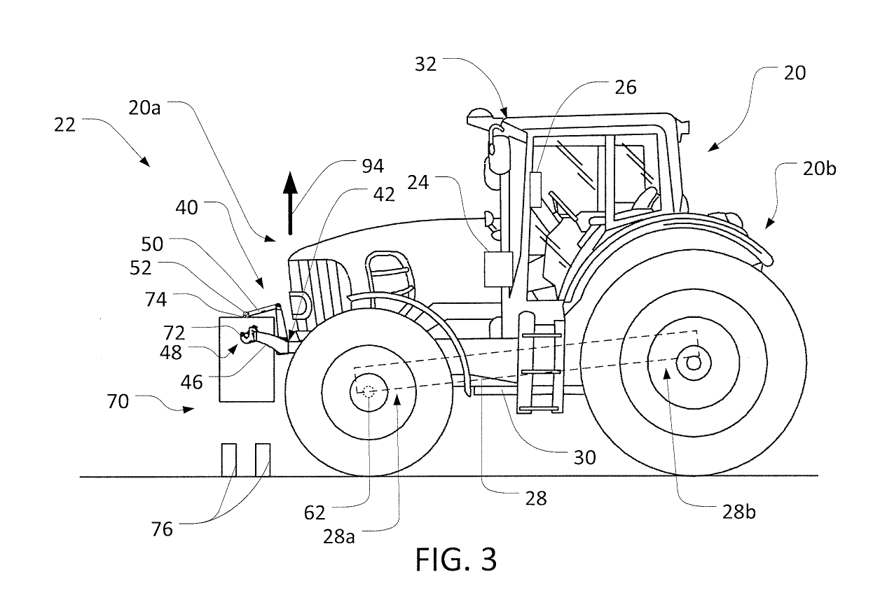

Referring also to FIG. 3, once the hitch points 48 on the three-point hitch 40 have been appropriately aligned with the mounting pins 72 on the attachment 70, the suspension 28 can be actuated to raise the chassis 30 and thereby raise the attachment 70 with the hitch 40. In the implementation depicted, as indicated by arrow 94, the leading portion 28a of the suspension 28 has been actuated, such that the leading portion of the chassis 30 has been pivoted upward. In other embodiments, the chassis 30 can be lifted in other ways, including in a non-pivoting movement. As appropriate, once (or before) the attachment 70 has been lifted by the three-point hitch 40, the upper arm 50 can be secured to the pin-and-lug arrangement 74.

As depicted in FIG. 3, the leg pins 78 of the attachment 70 have been removed before the attachment 70 was lifted (e.g., after the pins 72 have been engaged by the hitch points 48), such that the legs 76 can be left on the ground for tractor operations using the attachment 70. To remove the attachment 70 from the tractor 20, the tractor 20 can accordingly be maneuvered to re-align the attachment 70 with the legs 76 and the suspension 28 controlled to appropriately lower the chassis 30. In other embodiments, other types of supports for an attachment can be used. For example, legs similar to the legs 76 can be configured as folding or telescoping legs, or the body of the attachment 70 can simply rest on the legs 76 or a similar platform.

The actuation of the suspension 28 to raise the chassis 30 can be controlled in various ways. In some implementations, the controller 24 can be configured to cause the suspension 28 to be raised based upon active, ongoing control by a user. For example, a user can engage the user interface 26 to continually instruct the controller 24 (e.g., via a touchscreen button) to raise the chassis 30 via the suspension 28, with the raising of the chassis 30 continuing only as along as the user provides the instructions (and the suspension remains within its maximum range of travel). In some implementations, the controller 24 can be configured to cause the suspension 28 to be raised based upon other types of user input. For example, a user can provide a target end height or a simple “Raise Suspension” instruction via the user interface 26 and the controller 24 can automatically raise the chassis 30 via the suspension 28 to the commanded height or a preset configuration. In some implementations, the controller 24 can be in communication with sensors or lookup tables so as to automatically determine an appropriate chassis height for a particular attachment and mounting frame or tractor operation.

Notably, in the example configuration depicted in FIG. 3 (and other similar configurations), the attachment 70 can be supported by the tractor 20 solely via the three-point hitch 40. Accordingly, securing an attachment to a work vehicle using the disclosed system can be relatively simple and low-cost, as compared to conventional systems in which multiple devices at multiple points on the vehicle must be used to appropriately attach an attachment.

As will be appreciated by one skilled in the art, certain aspects of the disclosed subject matter can be embodied as a method, system (e.g., a work vehicle control system included in a work vehicle), or computer program product. Accordingly, certain embodiments can be implemented entirely as hardware, entirely as software (including firmware, resident software, micro-code, etc.) or as a combination of software and hardware (and other) aspects. Furthermore, certain embodiments can take the form of a computer program product on a computer-usable storage medium having computer-usable program code embodied in the medium.

Any suitable computer usable or computer readable medium can be utilized. The computer usable medium can be a computer readable signal medium or a computer readable storage medium. A computer-usable, or computer-readable, storage medium (including a storage device associated with a computing device or client electronic device) can be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium can be any tangible medium that can contain, or store a program for use by or in connection with the instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be non-transitory and can be any computer readable medium that is not a computer readable storage medium and that can communicate, propagate, or transport a program for use by or in connection with an instruction execution system, apparatus, or device.

Aspects of certain embodiments are described herein can be described with reference to flowchart illustrations and/or block diagrams of methods, apparatus (systems) and computer program products according to embodiments of the invention. It will be understood that each block of any such flowchart illustrations and/or block diagrams, and combinations of blocks in such flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. A method for securing an attachment to a mounting frame that is attached to a work vehicle with a chassis and a suspension, the mounting frame including at least one frame attachment point disposed on at least one support, the method comprising:
causing the suspension to lower the mounting frame relative to ground by lowering the chassis of the work vehicle;
maneuvering the work vehicle to align the at least one frame attachment point with a corresponding at least one attachment point on the attachment; and
causing the suspension to raise the mounting frame relative to ground by raising the chassis of the work vehicle, the at least one frame attachment point engaging the corresponding at least one attachment point on the attachment, as the mounting frame is raised, in order to lift the attachment, the attachment being thereby supported by the work vehicle solely via the mounting frame.

2. The method of claim 1, further comprising:
attaching a movable support of the mounting frame to an additional attachment point on the attachment, in order to secure the attachment to the mounting frame.

3. The method of claim 1, wherein the at least one support of the mounting frame includes two lower arms, the lower arms being non-pivotally secured to the work vehicle.

4. The method of claim 1, wherein the at least one support extends one of forward of a leading end of the work vehicle and rearward of a trailing end of the work vehicle, such that the at least one frame attachment point is disposed, respectively, one of forward of the leading end of the work vehicle and rearward of the trailing end of the work vehicle.

5. The method of claim 4, wherein the at least one support extends forward of the leading end of the work vehicle;
wherein the suspension includes at least a front suspension; and
wherein causing the suspension to raise the mounting frame relative to ground includes causing the front suspension to raise the chassis of the work vehicle.

6. The method of claim 1, wherein the attachment includes one or more legs to support the attachment relative to ground before the attachment is lifted by the mounting frame, the one or more legs being one or more of foldable, collapsible, adjustable with regard to height, and non-destructively removable from the attachment, the method further comprising:
one or more of folding, collapsing, shortening, and removing the one or more legs of the attachment, after causing the suspension to raise the mounting frame such that the at least one frame attachment point engages the corresponding at least one attachment point on the attachment.

7. The method of claim 1, wherein the attachment includes one or more of a ballast weight, a rock box, a tool box, a tank for liquid, an agricultural implement, and a motorized vehicle.

8. The method of claim 1, wherein the work vehicle has a front overhang distance between a front axle of the work vehicle and a point of attachment of the mounting frame to the work vehicle; and
wherein a distance between the at least one frame attachment point and the point of attachment of the mounting frame to the work vehicle is smaller than the front overhang distance.

9. The method of claim 8, wherein the distance between the at least one frame attachment point and the point of attachment of the mounting frame to the work vehicle is smaller than sixty percent of the front overhang distance.

10. The method of claim 1, wherein a controller of the work vehicle causes the suspension to at least one of automatically lower and automatically raise the mounting frame relative to ground, based upon a user input at a control device in a cab of the work vehicle.

11. An attachment system for securing an attachment to a work vehicle with a suspension, the attachment system comprising:
a mounting frame attached to the work vehicle at one or more vehicle attachment points, the mounting frame including at least one support extending one of forward of a leading end of the work vehicle and rearward of a trailing end of the work vehicle, such that at least one frame attachment point on the at least one support is disposed, respectively, one of forward of the leading end of the work vehicle and rearward of the trailing end of the work vehicle;
a user interface configured to receive user commands for adjustment of the suspension; and
a controller configured to cause the suspension to be raised and lowered relative to ground based upon the user commands received at the user interface;
wherein, when the at least one frame attachment point is vertically aligned with a corresponding at least one attachment point on the attachment and a user command for lifting is received at the user interface, the controller causes the suspension to raise the mounting frame relative to ground by raising a chassis of the work vehicle, such that the mounting frame lifts the attachment.

12. The attachment system of claim 11, wherein the mounting frame further includes a movable support configured to move relative to the at least one support in order to attach to an additional attachment point on the attachment and thereby secure the attachment to the mounting frame.

13. The attachment system of claim 11, wherein the at least one support of the mounting frame includes two lower arms, the lower arms being non-pivotally secured to the work vehicle.

14. The attachment system of claim 13, wherein the at least one frame attachment point includes first and second frame attachment points at front ends of the two lower arms, each of the first and second frame attachment points including an open hook to engage the attachment.

15. The attachment system of claim 13, wherein the mounting frame further includes an upper arm pivotally secured to one of the mounting frame and the work vehicle chassis.

16. The attachment system of claim 11, wherein the attachment includes one or more legs to support the attachment relative to ground before the attachment is lifted by the mounting frame, the one or more legs being one or more of foldable, collapsible, adjustable with regard to height, and non-destructively removable from the attachment.

17. The attachment system of claim 11, wherein the attachment includes one or more of a ballast weight, a rock box, a tool box, a tank for liquid, an agricultural implement, and a motorized vehicle.

18. The attachment system of claim 11, wherein the work vehicle has a minimum front overhang distance between a front axle of the work vehicle and the one or more vehicle attachment points; and
wherein a distance between the at least one frame attachment point and the one or more vehicle attachment points is smaller than the minimum front overhang distance.

19. The attachment system of claim 18, wherein the distance between the at least one frame attachment point and the one or more vehicle attachment points is smaller than sixty percent of the minimum front overhang distance.

20. An attachment system for a work vehicle, the attachment system comprising:
a three-point hitch attached to the work vehicle at one or more vehicle attachment points disposed at a front of the work vehicle, the three-point hitch including two non-pivoting lower supports extending forward of a leading end of the work vehicle such that a respective hitch point on each of the lower supports is disposed forward of the leading end of the work vehicle, the three-point hitch also including a pivoting upper support with a hitch point on the upper support that is also disposed forward of the leading end of the work vehicle;
a user interface configured to receive user commands for adjustment of a suspension of the work vehicle;
an attachment with one or more legs to support the attachment relative to ground, the one or more legs being one or more of foldable, collapsible, adjustable with regard to height, and non-destructively removable from the attachment, the attachment further including three hitch points corresponding, respectively, to the three hitch points on the upper and lower supports of the three-point hitch; and
a controller configured to cause at least a front portion of the suspension of the work vehicle to raise and lower a chassis of the work vehicle relative to ground, based upon the user commands received at the user interface;
wherein, when the hitch points on the lower supports are vertically aligned, respectively, with the corresponding hitch points of the attachment and a user command for lifting is received at the user interface, the controller causes at least the front portion of the suspension to raise the three-point hitch relative to ground by raising the chassis of the work vehicle, such that the three-point hitch lifts the attachment, the attachment being thereby supported by the work vehicle solely via the three-point hitch.
